(19) United States
(12) Patent Application Publication
(10) Pub. No.: US 2006/0265595 A1
(43) Pub. Date: Nov. 23, 2006

(54) Cascading key encryption

(76) Inventor: Salvatore E. Scottodiluzio, Holy Springs, NC (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/551,397

(22) PCT Filed: Mar. 30, 2004
(86) PCT No.: PCT/US04/09682

§ 371 Date: Jul. 7, 2006

Related U.S. Application Data
(60) Provisional application No. 60/459,720, filed on Apr. 2, 2003.

(51) Int. Cl. H04L 9/00

(52) U.S. Cl. 713/180; 380/45

(57) ABSTRACT

A method for securely transmitting data involves generating keys depending on previous keys and additional information, such as a password, in order to create a pseudo one-time pad. The data is encrypted using the pseudo one-time pad prior to transmission. Only the initial key and minimal additional data are transferred between the sender and receiver in order to synchronize the keys.

### FIELD OF THE INVENTION

This invention relates generally to cryptographic systems and methods, and, more particularly, to cascading key encryption such that a message object may be encrypted with multiple keys derived from a first key known to the sender and receiver of the message.

### BACKGROUND OF THE INVENTION

Secure communication between two parties has always been an important but difficult task. The moment information is shared between two parties, a third, unauthorized party may be able to access this information as well. The problem is magnified when the two authorized parties are separated by a distance, so that information must be passed in the form of messages rather than by direct communication. Historically, the content of messages has sometimes been protected by cryptography, in which the content is altered by transformation into another form which is understandable only by the intended recipient or recipients of the message.

As the technology for transferring information has become increasingly complex and sophisticated, so has the technology of cryptography. Currently, cryptography may be performed by encoding the original message into an incomprehensible protected message according to mathematical algorithms using a particular key. Only the correct recipient should have both the same algorithm and the particular key needed to decode the protected message into the original message. Thus, the incomprehensible encoded message can be freely transmitted over a relatively insecure communication channel, while remaining secure to all but the correct recipient.

The security of the encoded message depends both upon the possession of the key and the ability of the algorithm to resist being broken by an unauthorized third party. A third party could try to guess the identity of the key, in effect copying it, and then use the actual key to decode the message. Accordingly, the longer the key, the more difficult either guessing attacks or brute force attacks become.

Common encryption methods include such algorithms as DES (Data Encryption Standard) and RSA (Rivest-Shamir-Adleman) encryption techniques. While these techniques are robust and allow for variable keys, they are still potentially subject to defeat by application of repetitive analysis to decode the cipher that is cycled many times in a typical message. For example, the DES algorithm with a 56-bit key was thought to be impregnable at the time of its inception. However, less than two decades later, DES with the 56-bit key could theoretically have been broken in seven hours by brute force with a highly sophisticated computer. To solve the problem, the key was lengthened to 128 bits. Other algorithms have proven to be susceptible to brute force attacks, and are now used with longer keys to reduce their vulnerability to attacks. An additional layer of security is provided by using public key-private key pairs. For example, in the PGP (Pretty Good Privacy) cryptography software, the sender encrypts the message using the public key, and the recipient decrypts it with the private key:

However, it remains that encryption methods based upon mathematical algorithms and keys can potentially be broken by a brute force attack. As computer technology becomes more sophisticated and as new mathematical functions related to these algorithms become available, such brute force attacks become easier to manage, thereby rendering the encrypted data vulnerable to unauthorized interception. Thus, expecting mathematical algorithms alone to provide all of the security for information transfer is clearly not sufficient.

The most secure and provable encryption method is One Time Pad (OTP), which is well known to those skilled in the art. The OTP cryptosystem may take many forms. In its best known form, OTP uses a large non-repeating set of truly random key letters, written on sheets of paper and then glued together in a pad. The sender uses each key letter on the pad to encrypt exactly one plaintext (i.e., non-encrypted) character (typically, by an exclusive-OR operation). The receiver of the message has an identical pad and uses in turn each key on the pad to decrypt each letter of the cyphertext,(i.e., the encrypted message). The sender destroys the pad after encrypting the message, and the receiver destroys the pad after decrypting the message. Of course, the OTP approach has been adapted, for example, to encrypt digital messages. In such an application, a random string of bits having a length equal to the length of a digital message are used to encrypt the digital message before the message is transmitted.

OTP is theoretically unbreakable by a brute force attack on the encrypted message itself. Since random numbers are used for the encoding, the random number used for the encoding cannot be guessed or derived according to a mathematical algorithm, or according to statistical analysis. The pad on which the key is written can be literally a physical pad of paper, on which a series of random numbers is written, or the pad could also be in the form of an electronic storage hardware device such as a diskette. Of course, OTP is only secure as the key itself. The pad of paper or diskette with the key could be physically stolen or copied, but such an occurrence is relatively easier to guard against and to detect than electronic theft of the messages.

A more significant problem with OTP is that the key set must be at least as large as the input set. In other words, a document containing one million characters requires a key of one million characters, and this key must be exchanged between the receiver and sender. Such large key sizes make it prohibitively inefficient to transfer the key. Thus, as currently available, OTP is both cumbersome and not practicable for communication of large messages.

As noted above, present encryption technologies other than OTP have begun to utilize very large keys as well in an attempt to make it more difficult to break the key. Additionally, the use of a single key means that if an attack breaks the key, the entire encrypted message object is compromised. Accordingly, there is a need for systems and methods of encryption that are highly secure but do not require the use and exchange of large, single keys.

### SUMMARY OF THE INVENTION

The present invention provides methods and systems of encryption that may be used in applications such as digital rights management, secure email, secure file transfer, secure data storage, satellite transmissions, or other applications where sensitive data may need to be stored or transmitted. Certain exemplary embodiments according to this invention provide very secure encryption without the sender and receiver having to exchange multiple and/or large amounts of data regarding the encryption key.

A first key is used to generate multiple additional keys, and each of the set of keys is used to encode a portion of a message object. Only the sender and receiver know the first key, password or passphrase, shift points (or functional relation that defines the shift points), and the formula or function for generating additional keys from the first key, and this information should be transmitted over a secure channel. The message object to be encrypted is partitioned into two or more portions, with each portion having a separate, unique key. The generation of a second key from the first key, a third key from the second key, and so on is referred to as cascading of the encryption keys. A new key for each portion of the message object is created based on the immediately preceding key such that each portion of the message object is uniquely encoded. Only the first key of the set of encryption keys is exchanged by the receiver and sender of the message object, reducing the size of encryption key data typically required to be exchanged. Similar to OTP, the first key, and all subsequent keys generated therefrom, should be used only once for encryption and decryption of a message object.

The first key may be generated in a variety of ways well known to those skilled in the art provided the source for the key is random. An exemplary embodiment utilizes a piece of digital media to generate the first key. Thus, a first, seed key is provided, and a well understood formula for generating additional, unique keys from the seed key is used to encrypt each portion of the message object. By using multiple keys rather than a single key, the message object is more secure. Even though subsequent keys are generated based on a first key, without access to the password and shift points of the message object, breaking one key does not provide any clues to breaking the other keys. Furthermore, the one time use of the key set provides additional security.

The number of portions that the message object is divided into is completely arbitrary and is determined by the sender and receiver of the message object based on time, security, and other considerations. There must be at least one shift point during the encoding process, otherwise there is only the first key and no cascading of the key. The more shift points present, the more cascading occurs and the more secure the encrypted message becomes.

### BRIEF DESCRIPTION OF THE DRAWINGS

FIG. 1 depicts encryption process flow according to an exemplary embodiment of the present invention.

FIG. 2 shows decryption process flow according to an exemplary embodiment of the present invention.

### DETAILED DESCRIPTION OF THE INVENTION

The present invention provides methods and systems of encryption that may be used in applications such as digital rights management, secure email, secure file transfer, secure data storage, satellite transmissions, or other applications where sensitive data may need to be stored or transmitted. Certain exemplary embodiments according to this invention provide very secure encryption without the sender and receiver having to exchange multiple and/or large amounts of data regarding the encryption key.

A first key is used to generate multiple additional keys, and each of the set of keys is used to encode a portion of a message object. The message object to be encrypted is partitioned into two or more portions, with each portion having a separate, unique key. The generation of a second key from the first key, a third key from the second key, and so on (depending on the number of portions into which the message object is divided) is referred to as cascading, of the encryption keys. A new key for each portion of the message object is created based on the immediately preceding key such that each portion is uniquely encoded. Only the first key of the set of encryption keys is exchanged by the receiver and sender of the message object, reducing the size of encryption key data typically required to be exchanged. Additional information, including a password or passphrase, shift points or a formula or function for determining shift points (described further below), and a well understood formula for cascading the keys (i.e., generating additional keys from the first key), must also be shared or exchanged between the sender and receiver, but the size of this additional information is small relative to the size of the first key.

The first key, and the subsequent keys generated therefrom, are to be used only once and then destroyed. The first key may be generated in a variety of ways well known to those skilled in the art provided the source for the key is random. An exemplary embodiment utilizes a piece of digital media to generate the first key. This embodiment capitalizes on the random nature of digital media and utilizes that as a seed generator. The digital media used may-be, for example, video content, audio content, a digital image of a fingerprint, and numerous other digital media. For example, the digital media provided for the first key may be several bytes of video data or an audio portion (e.g., from 0:06:23 to 0:08:27) of a movie on DVD. Thus, a first, seed key is provided, and a well understood function for generating additional, unique keys from the seed key is used to encrypt each portion of the message object.

The number of portions that the message object is divided into is completely arbitrary and is determined by the sender and receiver of the message object based on time, security, and other considerations. Shift points or a shift index indicate the point or points within a message object at which the key is to be changed or define a-functional relationship by which such points are to be determined. There must be at least one shift point during the encoding process, otherwise there is only the first key and no cascading of the keys.

The more shift points present, the more cascading occurs and the more secure the encrypted message becomes. Shift points may be determined arbitrarily based on time, size, and security considerations associated with the data. Shift points may be at every symbol (further defined below) within the message object, but this would require substantial time for encryption and decryption. For example, if time to encrypt and decrypt the message object is not an issue and high security is needed, then a large number of shift points may be utilized. If, however, a limited time is available to encrypt and decrypt the message object and the data only needs to be moderately secure, a smaller number of shift points is used. A few examples for setting shift points are include the length of the message divided by some modulus, the length of the pass phrase divided by an arbitrary number, pre-defined shift points at arbitrary symbols within the message object, or any other way devised by the sender and receiver.

As noted above, the first and all other keys of the key set are used only once. Similar to OTP, the sum total size of the keys equals at least the size of the message object. However, rather than having a single key as large as the message object, the present invention allows for the use of multiple keys that may all be generated from a first key. The first key corresponds in size to only a first portion of the message object, and the first key is the only key exchanged by the sender and receiver of the message. Accordingly, exchange of keys is less cumbersome than with OTP because the first key is much smaller than the size of the entire message object.

Additionally, by using multiple keys rather than a single key, the message object is more secure. A hacker would have to break all keys to have access to the entire message object. Even though subsequent keys are generated based on a first key, without access to the password and shift points of the message object, breaking one key does not provide any clues to breaking the other keys.

Encryption Process

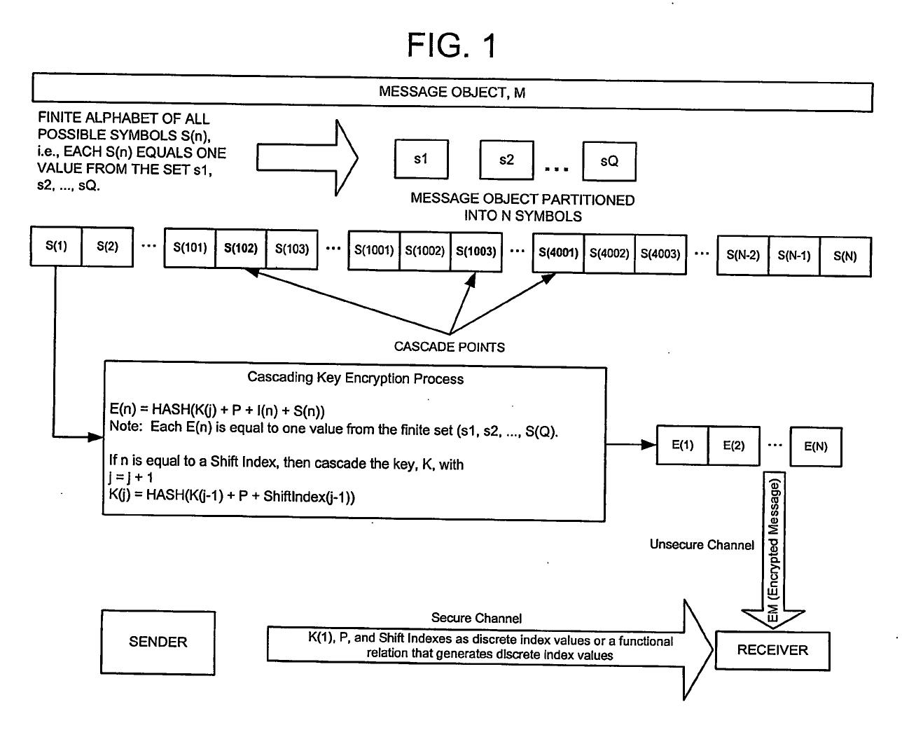

An exemplary embodiment of an encryption process according to the present invention is shown in FIG. 1 and described below, using the following definitions:

Message (M): The message object being encrypted.

Symbol (S): The smallest unique unit in the language of the message object. The language must have a finite alphabet set. Some elementary examples include an 8-bit byte (with values 0-255), the English alphabet (52 values, including both uppercase and lowercase letters), or ASCII code. Message object M includes a plurality of symbol units of size S, and each S is taken from a finite alphabet set s1, s2, . . . , sQ, where Q is a finite number.

Key (K): The unique piece of data used to encrypt/decrypt the message. Several examples, particularly using digital media, have been provided herein.

Password or passphrase (P): A password, which may or may not be unique.

Shift points (ShiftIndex): The threshold or index indicating the, point(s) within message object M at which key K is to be changed or cascaded. Generally, the shift index forms a table of values that indicate certain symbols within message object M where key K is to be changed. The shift index table may constructed in any suitable manner well known to those skilled in the art.

Hash (HASH): A message digest that is considered secure, such as MD5, SHA-1, and similar hash algorithms which are well understood by those skilled in the art. According to the Federal Information Processing Standards Publication (FIPS) 186, “A hash function is used in the signature generation process to obtain a condensed version of data, called a message digest. The message digest is then input to the DSA to generate the digital signature. The digital signature is sent to the intended verifier along with the signed data (often called the message).”

Iteration (I): The number of times a given symbol, S, has occurred within a message object M.

Encrypted Symbol (E): The symbol after encryption.

Before encrypting message object M, a table mapping each S(i) to an iteration count I(i) is created. I(i) provides a count of how many times each symbol occurs in message object M. For example, suppose s5 occurs three times in message object M at S(9), S(109), and S(10237). At the first occurrence when S(9)=s5, I(9)=1. On the second occurrence when S(100)=s5, I(9)=2; On the third occurrence when S(10237)=s5, I(9)=3. This table mapping is performed so that a different output is obtained for each symbol S(n) during the encryption process, even though several symbols may have the same value (e.g., s5 in the example given), each time the hash algorithm is run.

Let S(1) = First symbol in message object M.
Let S(N) = Last symbol in message object M.
Let I(n) = Count of occurrences of symbol S(i) thus far.
Set j = 1
FOR n = 1 to N
{

E(n) = HASH(K(j) + P + I(n) + S(n))
Increment I(n) for occurrence of S(n)
IF (n equals ShiftIndex(j))
{

j = j + 1
K(j) = HASH (K(j−1) + P + ShiftIndex(j−1))

}
Write E(n) to Output

The HASH function takes the key (beginning with K(1), the first key known to both parties), password, iteration value, and symbol value and creates a random value. If n is equal to a shift point, key K is cascaded with j=j+1, and encryption of the second portion of message object M begins with new key K. The second portion of message object M is encrypted using new key K until the next shift point is reached, where new key K is cascaded again, and so on, until all portions of message object M are encrypted. As shown in FIG. 1, shift points are predefined at S(102), S(1003), and S (4001). The encrypted message EM may then be transmitted to the receiver over any channel, and the sender should destroy the key set.

Decryption Process

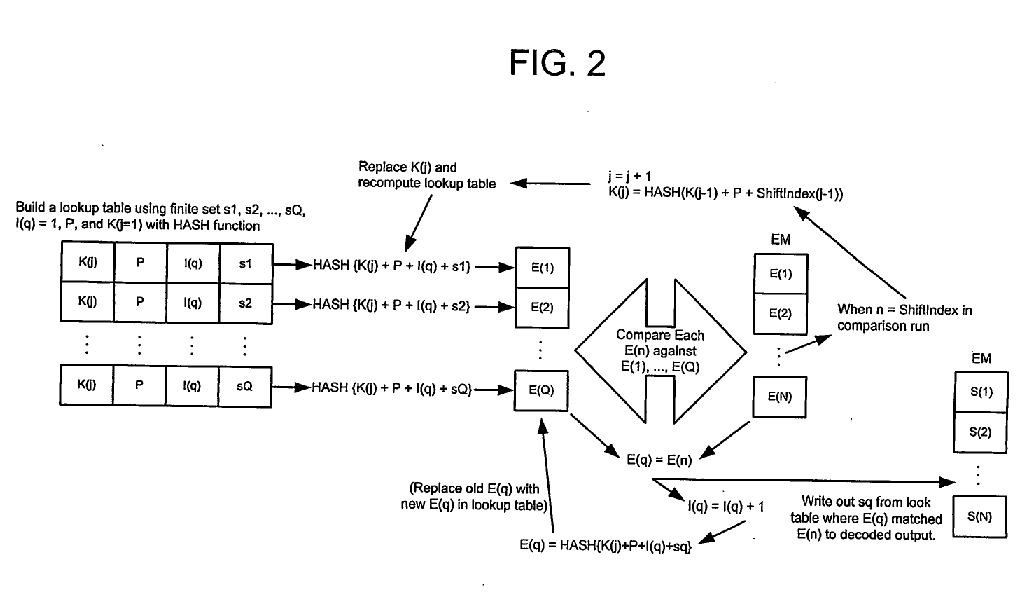

An exemplary embodiment of a decryption process according to the present invention is shown in FIG. 2 and described below, using the definitions above:

As shown in FIG. 1, the receiver already has knowledge of first key K(1), password P, the shift points, and the hash function used to generate subsequent keys. To decrypt an encrypted message EM, a lookup table of encrypted symbols is constructed using all symbol values in the finite alphabet, setting I(q)=1, for first key K(j=1). For each sq from s1 to sQ, E(q)=HASH (K(j)+P+I(q)+sq) is computed. If n equals a shift point, then another look up table is constructed for the next key to decode the next portion of message object M, as shown in FIG. 1.

Let E(1) = First symbol in EM.
Let E(N) = Last symbol in EM.
Let I(q) = 1.
FOR n = 1 to N
{

IF(E(n) = E(q))
{

Write sq from table as decoded symbol
I(q) = I(q) + 1
E(q) = HASH(K(j) + P + I(q) + sq)
Replace old E(q) with new E(q) in lookup table

}
IF(n = ShiftIndex(j))
{

j = j + 1
K(j) = HASH(K(j−1) + P + ShiftIndex(j−1))
Recompute entire lookup table values using current I(q) and new

K(j)

}

}

### EXAMPLE 1

In an exemplary embodiment, digital video, such as first run cinema content, may be encrypted. This invention is particularly valuable for encrypting such content because high security is necessary. For example, a theater owner that is to receive first run cinema content may provide the film distributor with a piece of digital media that is to be used to encode the cinema content.

The distributor uses the digital media to create cascading keys to encrypt the cinema content and sends encrypted DVDs to the theater owner, who uses the key, password, shift points, and well defined formula for generating subsequent keys from the first key to decrypt the content. Only the sender and receiver know the first key, password, shift points (or functional relation that defines the shift points), and the formula for generating additional keys from the first key, and this information should be transmitted over a secure channel.

A very simple illustration of using a piece of digital media to encrypt the first symbol of a message object is now provided:

| | | | | | | | |
|---|---|---|---|---|---|---|---|
| 0, 0 | 0, 1 | 0, 2 | 0, 3 | 0, 4 | 0, 5 | 0, 6 | 0, 7 |
| 1, 0 | 1, 1 | 1, 2 | 1, 3 | 1, 4 | 1, 5 | 1, 6 | 1, 7 |
| 2, 0 | 2, 1 | 2, 2 | 2, 3 | 2, 4 | 2, 5 | 2, 6 | 2, 7 |
| 3, 0 | 3, 1 | 2, 3 | 3, 3 | 3, 4 | 3, 5 | 3, 6 | 3, 7 |
| 4, 0 | 4, 1 | 2, 4 | 3, 4 | 4, 4 | 4, 5 | 4, 6 | 4, 7 |
| 5, 0 | 5, 1 | 2, 5 | 3, 5 | 4, 5 | 5, 5 | 5, 6 | 5, 7 |
| 6, 0 | 6, 1 | 2, 6 | 3, 6 | 4, 6 | 6, 5 | 6, 6 | 6, 7 |
| 7, 0 | 7, 1 | 2, 7 | 3, 7 | 4, 7 | 7, 5 | 6, 7 | 7, 7 |

The above table represents a digital image. In practice, the implementer of an embodiment of this invention determines the most suitable manner in which to generate a unique fingerprint of the digital media. In this simple example, the above table represents a digital image. The x, y coordinates in bold type are chosen at random from the image. Assume the password provided is “my password” and the hash function chosen is MD5. To encrypt a first symbol “A” in its first iteration (i.e., I(1)) using the above image and password: MD5(“5,00,12,73,36,53,61,7my passWordA1”) 5e78d4a64ad7728562ea828893244ece in hexadecimal format. Each subsequent symbol is encrypted in the same manner, where the input values for the symbol and iteration change. When a shift point occurs, a new key is cascaded from the above key, and encryption continues.

The foregoing description of the exemplary embodiments of the invention has been presented only for the purposes of illustration and description and is not intended to be exhaustive or to limit the invention to the precise forms disclosed; Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope.

What is claimed is:

1. A method for secure data transmission using multiple encryption keys comprising:
dividing a message object to be encrypted into a plurality of portions, each portion being associated with a shift point;
utilizing a first key to encode a first portion of the message object;
when a first shift point occurs, generating a second key by executing a function that uses the first key and additional information;
utilizing the second key to encode a second portion of the message object;
upon completion of encoding of all of the plurality of portions of the message object, transmitting the encrypted message object to a receiver and destroying the keys.

2. The method of claim 1, further comprising:
when each subsequent shift point occurs, generating a subsequent key by executing the function using a current key and additional information; and
utilizing the subsequent keys to encode subsequent portions of the message object.

3. The method of claim 1, further comprising transmitting at least a portion of the additional information to the receiver for decoding of the encrypted message, wherein the portion of the additional information comprises a password and shift points.

4. The method of claim 1, wherein the additional information comprises a password, an iteration value, and a symbol value, and the function executed is a hash algorithm.

5. The method of claim 1, wherein the first key is a piece of digital media.
